(19) United States
(12) Patent Application Publication
(10) Pub. No.: US 2016/0219874 A1
(43) Pub. Date: Aug. 4, 2016

(54) BIODEGRADABLE PLANT WOUND DRESSING COMPOSED OF ELECTROSPUN NANOFIBERS

(71) Applicant: The Board of Trustees of the University of Illinois, Urbana, IL (US)

(72) Inventors: Alexander L. Yarin, Clarendon Hills, IL (US); Soumyadip Sett, Oak Park, IL (US); Minwook Lee, Chicago, IL (US); Suman Sinha-Ray, Chicago, IL (US)

(73) Assignee: The Board of Trustees of the University of Illinois, Urbana, IL (US)

(21) Appl. No.: 14/997,698

(22) Filed: Jan. 18, 2016

Related U.S. Application Data
(60) Provisional application No. 62/119,429, filed on Feb. 23, 2015.
(60) Provisional application No. 62/109,684, filed on Jan. 30, 2015.
(60) Provisional application No. 62/109,304, filed on Jan. 29, 2015.

(51) Int. Cl. A01N 25/34; A01N 31/02; A01N 37/14; A01G 1/00; A01N 63/02; D01D 5/00; A01G 7/06; A01N 65/20; A01N 25/24

(52) U.S. Cl. CPC A01N 25/34; A01N 65/20; A01N 31/02; A01N 37/14; A01N 25/24; A01N 63/02; D01D 5/003; A01G 7/06; A01G 1/001; D10B 2321/06; D10B 2331/041; D10B 2401/12

(57) ABSTRACT

A plant wound dressing composed of a blend of polymers and methods for their manufacture and use are described.

This application claims benefit of priority to U.S. Provisional Application Ser. No. 62/119,429, filed Feb. 23, 2015; 62/109,684, filed Jan. 30, 2015; and 62/109,304, filed Jan. 29, 2015, the contents of which are incorporated herein by reference in their entireties.

### BACKGROUND

Plants and vines are often susceptible to microbial attack, especially at pruning locations. For example, Vine Decline or esca, typically caused by Phaeomoniella and Phaeoacremonium species is often found in grapevines. It causes huge economic losses through yield reduction and the number of cases has been increasing for decades. Esca disease has been reported in most vineyards in Europe. It also became a world-wide problem after the fatal disease spread to countries including Canada, the US, and New Zealand.

The esca-infected vine rots at the heart wood and develops tiger stripes on the leaves and black measles on the berries. In most cases, the entire vineyard should be replanted because the spores are airborne. This kind of wound-infecting disease can be spread by rain, wind, insects and birds to other vines, in particular through pruning locations. Indeed, most young vines are infected by esca and decline through wounds. The sites exposed to the atmosphere, such as wounds or pruning cuts, are dangerous channels for the fungal invaders.

Conventionally, esca has been controlled by cutting and burning the infected prune. In addition, sodium arsenite has been used to control the widespread attack of esca. However, this fungicide has now been banned in many countries. While prune paste and wound dressing, e.g., wax, can be used to protect the exposed sites from the environment, these agents also delay wound closure or kill the plant tissues or cells.

Pruning wounds can also facilitate the spread of other microbial diseases including e.g., fungal and bacterial canker diseases such as Eutypa dieback, Botryosphaeria canker and Leucostoma canker as well as devastating diseases such as ‘Chestnut blight,’ caused by Cryphonectria parasitica. Therefore, there is a need in the art for various approaches to limit the spread of microbial disease.

US 2010/0275331 describes a protective layer for coating leaves of plants, wherein the protective layer is composed of at least one sol-gel with nanoscale particles.

US 2014/0045695 describes biodegradable and biocompatible polymers formed in fibrous sheet-like structures that contain active ingredients such as fungicides and antibacterials for use in crop protection.

Greiner (Mar. 16-20, 2014; 247th National Spring Meeting of the American-Chemical-Society, Volume: 247) suggests polymer nanofiber nonwovens of biodegradable polyesters as possible wound coverage for the blocking of fungi spores in order to prevent the ESCA disease.

### SUMMARY OF THE INVENTION

This invention is a biodegradable plant wound dressing composed of a plurality of electrospun nanofibers produced from a blend of at least two different polymers, wherein at least one of the polymers is a biopolymer and said dressing is microorganism impermeable. In some embodiments, the biopolymer is a starch, cellulose, hemicellulose, lignin, pullulan, alginate, chitin, chitosan, dextran, or protein. In other embodiments, the biopolymer is derived from biowaste or a by-product. In certain embodiments, the other polymer is a synthetic polymer such as a polyvinyl alcohol, polycaprolactone, polyesteramide, modified polyethylene terephthalate, polylactic acid, polyglycolic acid, polyalkylene carbonate, polyhydroxyalkanoate, poly-3-hydroxybutyrate, poly-3-hydroxyvalerate, poly-3-hydroxybutyrate-co-4-hydroybutyrate, poly-3-hydroxybutyrate-co-3-hydroxyvalerate copolymer, poly-3-hydroxybutyrate-co-3-hydroxyhexanoate, poly-3-hydroxybutyrate-co-3-hydroxyoctanoate, poly-3-hydroxybutyrate-co-3-hydroxy decanoate, poly-3-hydroxybutyrate-co-3-hydroxyoctadecanoate, polybutylene succinate, polybutylene succinate adipate, an aliphatic-aromatic copolyester, polyethylene succinate or a combination thereof. In yet other embodiments, the biodegradable plant wound includes at least on adhesive, e.g., a water soluble, that is electrospun with the blend of at least two different polymers or is electrosprayed onto the electrospun nanofibers. In still further embodiments, the biodegradable plant wound includes a base membrane, preferably a biodegradable base membrane such as rayon. The biodegradable plant wound dressing of the invention is characterized as, but not limited to, having pores of less than about 6 microns and/or (a) a peel force of between 0.0005 N and 0.1500 N; (b) a normal specific adhesive energy of between 0.01 N/m and 50 N/m; (c) a shear adhesive specific energy of between 1 N/m and 500 N/m; or (d) a combination of any one of (a), (b) and (c). Methods for producing the biodegradable plant wound dressing and using the same to prevent microbial infection of a plant wound are also provided.

### BRIEF DESCRIPTION OF THE DRAWINGS

FIG. 1 depicts the functionality of the developed sticky green nano-textured dressing of this invention.

FIGS. 2A-2B show the peel force of different samples.

FIGS. 3A-3B show the normal specific adhesive energy of different samples.

FIGS. 4A-4F show the peel force for electrosprayed adhesive AD1: sample SPv01 (FIG. 4A), sample SPc01 (FIG. 4B), and a comparison between the two samples (FIG. 4C); and similar peel force graphs for adhesive AD2: sample SPv02 (FIG. 4D; numbers indicate cycle number), sample SPc02 (FIG. 4E), and a comparison between the latter two samples (FIG. 4F).

FIG. 5 shows the shear specific adhesive energy in repeated tests of SPv02 and SPc02. The horizontal axis shows the number of the test in which the adhesive energy was measured, for example in test 4, the same sample has been stuck to the surface and removed for the 4th time.

FIG. 6 shows the shear specific adhesive energy in the first test of SPv01, SPc01, SPv02 and SPc02 samples for the 0.83 kPa applied pressure.

### DETAILED DESCRIPTION OF THE INVENTION

Many vines and other plants are susceptible to microbial attack at pruning sites or other wounds. A solution for preventing microbial infection of plant wounds in an environmentally friendly way has now been found. More specifically, a nonwoven wound dressing or patch has been developed to physically block microbial penetration at pruning sites or other wounds yet maintain breathability. In this respect, the wound dressing is gas permeable and microorganism impermeable. The nonwoven wound dressing or patch is composed of a plurality of electrospun nanofibers produced from a blend of at least two different polymers, wherein at least one of the polymers is a biodegradable biopolymer.

As used herein, the term “wound dressing,” “patch,” “nonwoven wound dressing,” or “nonwoven patch” refers to a structure or a web of material that has been formed without use of traditional fabric forming processes, such as weaving or knitting, to produce a structure of individual fibers or threads that are intermeshed, but not in an identifiable, repeating manner as is found in typical woven webs.

A nonwoven wound dressing or patch of this invention is preferably formed by electrospinning. “Electrospinning” refers to a technology which produces nano-sized fibers referred to as electrospun fibers. Electrospinning is an inexpensive, effective, and simple method for producing non-woven nanofibrous mats, which intrinsically have ˜10³ times larger specific surface to volume ratios, increased flexibility in surface functionalities, improved mechanical performances, and smaller pores than fibers produced using traditional methods. The necessary components of an electrospinning apparatus include a high power voltage supply, a capillary tube with a needle or pipette, and a collector that is usually composed of a conducting material. The collector is held at a relatively short distance from the capillary tube, which contains a polymeric solution connected to the high power supply. Hanging droplets of the polymer solution are initially held in place in the capillary tube due to surface tension. However, at a critical voltage, a conical protrusion, commonly referred to as a Taylor Cone, is formed. From this, a nearly straight jet emerges and travels for a few centimeters. While the jet is moving conically, it experiences bending instabilities and its field is directed toward the collector, which is oppositely charged. By the time the jet reaches the collector, the solvent evaporates, thus dry polymer fibers are deposited on the collector. All currently observed polymer jets have been theoretically and experimentally observed to be continuous; therefore, electrospinning creates seemingly endless ultrafine fibers, referred to as nanofibers, that collect in a random pattern. The resulting mats (or membranes) from these small diameter fibers have very large surface area to volume ratios and small pore sizes.

As used herein, the term “nanofibers” refers to very small diameter fibers having an average diameter not greater than about 1500 nanometers (nm). Nanofibers are generally understood to have a fiber diameter range of about 10 to about 1500 nm, more specifically from about 10 to about 1000 nm, more specifically still from about 20 to about 900 nm, and most specifically from about 20 to about 800 nm. In instances where particulates are present and heterogeneously distributed on nanofibers, the average diameter of a nanofiber can be measured using known techniques (e.g., image analysis tools coupled with electro microscopy), but excluding the portions of a fiber that are substantially enlarged by the presence of added particles relative to the particle free portions of the fiber.

Various forms of electrospun nanofibers include branched nanofibers, tubes, ribbons and split nanofibers, nanofiber yarns, surface-coated nanofibers (e.g., with carbon), nanofibers produced in a vacuum, and so forth. The production of electrospun fibers is illustrated in many publication and patents, including, for example, Gibson, et al. (1999) “Electrospun Fiber Mats: Transport Properties,” AIChE Journal 45(1):190-195; Reneker, et al. (2007) Adv. Appl. Mech. 43-195; Reneker & Yarin (2008) Polymer 49:2387-2425; Greiner, et al. (2006) Appl. Microbiol. Biotechnol. 71:387-393; Yarin, et al. (2007) J. Mater. Chem. 17:2585-2599; Yarin (2011) Polym. Adv. Technol. 22:310-7.

In particular embodiments, the plant wound dressing is composed of a single layer of electrospun nanofibers. As used herein, the term “single layer of electrospun nanofibers” refers to a material composed of a single thickness which can be variable in size. In certain embodiments, the single layer of electrospun nanofibers is approximately 100 μm.

The plant wound dressing of this invention is biodegradable and biocompatible. The term “biodegradable” refers generally to a material that can degrade from the action of naturally occurring microorganisms, such as bacteria, fungi, yeasts, plants and algae; environmental heat, moisture, or other environmental factors. If desired, the extent of biodegradability may be determined according to ASTM Test Method 5338.92. In certain embodiments, the plant wound dressing of this invention remains intact for at least 6 to 10 weeks after being applied to the wound of a plant. The term “biocompatible” refers generally to a material that does not harm the plant or environment.

The electrospun nanofibers of the plant wound dressing are produced from a blend of at least two different polymers, in particular, at least two different biodegradable polymers. As used herein the term “polymer” refers to and generally includes, but is not limited to, homopolymers, copolymers, such as, for example, block, graft, random and alternating copolymers, terpolymers, etc. and modifications thereof. Unless otherwise specifically limited, the term “polymer” is intended to include all possible geometrical configurations of the material. These configurations include, but are not limited to, isotactic, syndiotactic and random symmetries. A blend of polymers refers to combinations of various types and amounts of polymers, such as those described below.

In particular embodiments, at least one of the polymers of the polymer blend is a biopolymer. A biopolymer refers to a biological polymer that is produced in nature and is typically extracted. By comparison, a synthetic polymer is a human-made polymer. Biopolymers that can be incorporated into the plant wound dressing of this invention include, for example, starch, cellulose, hemicellulose, pullulan, alginate, chitin, chitosan, dextran, lignin, and proteins. In particular embodiments, the biopolymer of the plant wound dressing is a protein. In some embodiments, the biopolymer is water soluble. In certain embodiments, the biopolymer is water insoluble. A biopolymer can be naturally water insoluble or modified to be water insoluble, e.g., by physical, chemical and/or enzymatic treatment.

Starch is a natural polymer composed of amylose and amylopectin. Amylose is essentially a linear polymer having a molecular weight in the range of 100,000-500,000, whereas amylopectin is a highly branched polymer having a molecular weight of up to several million. Although starch is produced in many plants, typical sources includes seeds of cereal grains, such as corn, waxy corn, wheat, sorghum, rice, and waxy rice; tubers, such as potatoes; roots, such as tapioca (i.e., cassava and manioc), sweet potato, and arrowroot; and the pith of the sago palm. Fine starch acetate nanofibers with a high tenacity have been produced using 90% (v/v) formic acid/water solvent system (Xu, et al. (2009) Biotechnol. Prog. 25:1788-95). Similarly, electrospinning of starch-polycaprolactone (30/70 wt %) produces nanofibers having a diameter of 130-180 nm (Jukola, et al. (2008) AIP Conf. Proc. 973:971).

Cellulose is the predominant constituent in cell walls of all plants. Cellulose is a complex polysaccharide with crystalline morphology. Cellulose differs from starch where glucose units are linked by β-1,4-glycosidic bonds, whereas the bonds in starch are predominantly α-1,4 linkages. The most important raw material sources for the production of cellulosic plastics are cotton fibers and wood. Non-woven mats of submicron-sized cellulose fibers (160-1280 nm in diameter) have been obtained by electrospinning cellulose or cellulose acetate solutions (Kim, et al. (2006) Polymer 47:5097-5107; Han, et al. (2008) Materials Lett. 62:759-62; Wang & Hsieh (2004) J. Polym. Sci. Part a-Polym. Chem. 42:4289-99).

Alginate is a linear polysaccharide that is abundant in nature as it is synthesized by brown seaweeds and by soil bacteria. Sodium alginate is the most commonly used alginate form in the industry since it is the first by-product of algal purification. Sodium alginate is composed of α-l-guluronic acid residues (G blocks) and β-d-mannuronic acid residues (M blocks), as well as segments of alternating guluronic and mannuronic acids. Nanofibers having an average diameter of 191 nm have been obtained by electrospinning an amphiphilic alginate derivate and polyvinyl alcohol (Chen, et al. (2015) Polymer Bull. 72:3097-3117).

Pullulan is a linear water-soluble polysaccharide mainly composed of maltotriose units connected by α-1,6 glycosidic units. Pullulan is obtained from the fermentation broth of Aureobasidium pullulans. Pullulan is produced by a simple fermentation process using a number of feedstocks containing simple sugars. Pullulan can be chemically modified to produce a polymer that is either less soluble or completely insoluble in water. Pullulan and pullulan/montmorillonite clay nanofiber mats have been fabricated by the electrospinning technique in aqueous solution (Karim, et al. (2009) Carbohydrate Poly. 78:336-42; Sun, et al. (2012) Appl. Mech. Mater. 268-70:198-201).

Chitin and chitosan are the most abundant natural amino polysaccharide and valuable bio-based natural polymers derived from shells of prawns and crabs. Currently, chitin and chitosan are produced commercially by chemical extraction process from crab, shrimp, and prawn wastes. Chitosan displays interesting characteristics including biodegradability, biocompatibility, chemical inertness, high mechanical strength, good film-forming properties, and low cost. Electrospinning of chitin has been performed with 1,1,1,3,3,3-hexafluoro-2-propanol (HFIP), trifluoroacetic acid/methylene chloride, and acetic acid as spinning solvents (Ohkawa, et al. (2004) Macromol. Rapid Commun. 25:1600-5; Duan, et al. (2004) J. Biomater. Sci. Polym. Ed. 15:797-811). Morphology of as-spun and deacetylated chitin (chitosan) nanofibers indicate fiber diameters in the range of 40 to 640 nm (Min, et al. (2004) Polymer 45:7137-42). See also Pillai & Sharma (2009) Trends Biomater. Artif. Organs 22:179-201.

Dextran is a bacterial polysaccharide that is composed of R-1,6 linked D-glucopyranose residues with some R-1,2-, R-1,3-, or R-1,4 linked side chains. Due to its biodegradability and biocompatibility, it has been used for various biomedical applications. Compared with other biodegradable polymers, dextran is inexpensive and readily available. Most importantly, dextran is soluble in both water and some organic solvents. Antibacterial electrospun scaffolds have been prepared by electrospinning of a solution composed of dextran, polyurethane and ciprofloxacin HCl (Unnithan, et al. (2012) Carbohydr. Polym. 90:1786-93).

Proteins of use as biopolymers of this invention, include, but are not limited to, gluten, soy protein, keratin (e.g., from human hair or bird feathers), casein, zein, collagen or gelatin. The production of electrospun nanofibers using proteins has been described in the art. See Table 1.

TABLE 1

| Protein | Solvent | Conc. | | Reference |
|---|---|---|---|---|
| 20% casein:80% | 5% aqueous | 5 | wt % | Xie & Hsieh |
| polyethylene oxide | triethanolamine | | | (2003) J. |
| (Mv 600,000) | | | | Mater. Sci. |
| | | | | 38: 2125-33 |
| 80% casein:20% | 5% aqueous | 10 | wt % | Xie & Hsieh |
| polyethylene oxide | triethanolamine | | | (2003) J. |
| (Mv 600,000) | | | | Mater. Sci. |
| | | | | 38: 2125-33 |
| 30% casein:70% | 5% aqueous | 10 | wt % | Xie & Hsieh |
| polyethylene oxide | triethanolamine | | | (2003) J. |
| (Mv 124,000- | | | | Mater. Sci. |
| 186,000) | | | | 38: 2125-33 |
| 50% casein:50% | 5% aqueous | 10 | wt % | Xie & Hsieh |
| polyethylene oxide | triethanolamine | | | (2003) J. |
| (Mv 124,000- | | | | Mater. Sci. |
| 186,000) | | | | 38: 2125-33 |
| Collagen Type I | HFIP | 0.083 | g/ml | Matthews, et |
| | | | | al. (2002) |
| | | | | Biomacromol. |
| | | | | 3: 232-8 |
| Collagen Type II | HFIP | n.a. | | Shields, et |
| | | | | al. (2004) |
| | | | | Tissue Eng. |
| | | | | 10: 1510-7 |
| Collagen Type III | HFIP | 0.04 | g/ml | Matthews, et |
| | | | | al. (2002) |
| | | | | Biomacromol. |
| | | | | 3: 232-8 |
| 50% Collagen Type | HFIP | 0.06 | g/ml | Matthews, et |
| II:50% Collagen | | | | al. (2002) |
| Type III | | | | Biomacromol. |
| | | | | 3: 232-8 |
| Gelatin Type A | 2,2,2- | 10-12.5 | wt % | Zhang, et al. |
| | trifluorethanol | | | (2005) J. |
| | (TFE) | | | Biomed. |
| | | | | Mater. Res. |
| | | | | Part B: Appl. |
| | | | | Biomater. |
| | | | | 72B: 156-65 |
| Gelatin | glacial acetic | 21-29% | (w/v) | Choktaweesap, |
| | acid and TFE, | | | et al. (2007) |
| | dimethylsulfoxide, | | | Polymer J. |
| | ethylene glycol or | | | 39: 622-31 |
| | formamide | | | |
| Wool | formic acid | 12 | wt % | Li & Yang |
| Keratin/Polyvinyl | | | | (2014) Adv. |
| Alcohol (50:50, | | | | Mater. Sci. |
| 60:40, 70:30) | | | | Engin. 2014: |
| | | | | Article ID |
| | | | | 163678 |
| human hair keratin/ | distilled water | 7 | wt % | Yong, et al. |
| polyethylene | | | | (2014) |
| oxide | | | | Materia (Rio |
| | | | | J.) 19: 382-8 |
| 50% Gelatin Type | TFE | 10 | wt % | Zhang, et al. |
| A:50% | | | | (2005) J. |
| Polycaprolactone | | | | Biomed. |
| | | | | Mater. Res. |
| | | | | Part B: Appl. |
| | | | | Biomater. |
| | | | | 72B: 156-65 |
| Zein | Aqueous ethanol | n.a. | | Yao, et al. |
| | | | | (2007) J. |
| | | | | Appl. Polym. |
| | | | | Sci. 103: 380-385 |
| Wheat Gluten | HFIP | 10% | (wt/v) | Woerdeman, et |
| | | | | al. (2005) |
| | | | | Biomacromol. |
| | | | | 6: 707-12 |

n.a., not available.

Biowaste is often referred to as biodegradable garden and park waste, food and kitchen waste from households, restaurants, caterers and retail premises, and comparable waste from food processing plants. A by-product is a substance or object, resulting from a production process, the primary aim of which is not the production of that item. The value of both biowaste and by-products can be realized when valuable components are extracted and used in other end products. Indeed, soy protein is one of the cheapest and most readily available biopolymers obtained as a by-product of soy-derived biodiesel. In this respect, certain embodiments of the present invention embrace the use of biopolymers derived from, e.g., extracted, recovered, or refined from, biowaste or by-products.

In addition to a biopolymer, the polymer blend of the biodegradable plant wound dressing includes a second polymer. The second polymer can be another biopolymer or, in certain embodiments, the second polymer is a synthetic polymer. Biodegradable polymers serving as a second polymer of use in the present invention include, but are not limited to, polyvinyl alcohol, polycaprolactone (PCL), polyesteramides, modified polyethylene terephthalate, polylactic acid (PLA) and its copolymers, terpolymers based on polylactic acid, polyglycolic acid, polyalkylene carbonates (such as polyethylene carbonate), polyhydroxyalkanoates (PHA), poly-3-hydroxybutyrate (PHB), poly-3-hydroxyvalerate (PHV), poly-3-hydroxybutyrate-co-4-hydroybutyrate, poly-3-hydroxybutyrate-co-3-hydroxyvalerate copolymers (PHBV), poly-3-hydroxybutyrate-co-3-hydroxyhexanoate, poly-3-hydroxybutyrate-co-3-hydroxyoctanoate, poly-3-hydroxybutyrate-co-3-hydroxy decanoate, poly-3-hydroxybutyrate-co-3-hydroxyoctadecanoate, polybutylene succinate, polybutylene succinate adipate, an aliphatic-aromatic copolyester, polyethylene succinate or a combination thereof. In some embodiments, the second polymer is polyvinyl alcohol. PCL is an inexpensive, FDA-approved water insoluble polymer without any toxicity and with controllable degradation. Accordingly, in particular embodiments, the second polymer is polycaprolactone.

The biopolymer:second polymer ratio can be in the range of 10:90 to 90:10 (w/w), and is preferably in the range of 15:85 to 60:40 (w/w). In particular embodiments, the ratio of biopolymer:second polymer is about 16:84, 50:50, or 40:60 (w/w).

Suitable solvents for the polymers disclosed herein can be selected from solvents known to those skilled in the art, including, but not limited to, sulfuric acid, formic acid, acetic acid, chloroform, tetrahydrofuran, dimethyl formamide, HFIP, TFE, trifluoroacetic acid, methylene chloride, water, acetone, dimethylsulfoxide, ethylene glycol, formamide, ethanol, triethanolamine and combinations thereof.

To provide sufficient mechanical support in handling prior to deposition on a plant, the plant wound dressing can also include a base membrane. In some embodiments, the base membrane is biodegradable. The base membrane can be a nonwoven or woven substrate or web made from natural or synthetic materials such as fibers of cotton, cellulose, rayon, LYOCELL (a form of rayon composed of regenerated cellulose fiber made by dissolving pulp using dry jet-wet spinning), acetate, cellulose acetate, silk, wool, hemp, spandex (including LYCRA), polyolefins (polypropylene, polyethylene, etc.), polyamide (NYLON 6, NYLON 6-6, etc.), acrylic, or polyester (polyethylene teraphthalate, trimethylene terephthalate), polyurethane, etc. The nanofibers may be directly deposited onto a base membrane where they form a mat, or the nanofibers may be formed into nanofiber mats and the mats deposited onto a base membrane. In certain embodiments, the base membrane is biodegradable. In particular embodiments, the base membrane is composed of rayon.

To facilitate adhesion of the wound dressing of this invention to a plant, the dressing can further include an adhesive. The wound dressing of this invention can adhere to all or a portion (e.g., 1-99%) of the plant wound without being detrimental to the plant. Accordingly, in certain embodiments, the adhesive is added directly to the electrospinning solution containing the at least two different polymers, i.e., a homogenous solution containing the at least two different polymers and adhesive is electrospun to produce nanofibers. Alternatively, the adhesive is electrosprayed onto the as-spun nanofiber mat. The adhesive can be water soluble or water insoluble. In certain embodiments, one or more water soluble adhesives are used. Examples of the adhesives include natural rubber, acrylic resins such as acrylic ester copolymers, polyvinyl acetate resins, silicone resins, oxazoline-modified silicones, such as poly(N-propanoylethyleneimine) grafted dimethylsiloxane/γ-aminopropylmethylsiloxane copolymer, urethane resins, and copolymers of these resins. They may be used either individually or a combination of two or more thereof. In certain embodiments, the adhesive is an acrylic resin or polyvinyl acetate resin. In other embodiments, the adhesive is non-toxic.

In additional to conventional adhesives, the wound dressing of this invention can include alternative adhesives, such as silk sericin and/or genipin. Silk sericin is extracted from pieces of cocoons from silkworms (Bombyx mori) using a high temperature and pressure degumming technique. Genipin (Methyl (1R,2R,6S)-2-hydroxy-9-(hydroxymethyl)-3-oxabicyclo[4.3.0]nona-4,8-diene-5-carboxylate) is found in traditional Chinese medicine and is extracted from gardenia fruit. It is an effective naturally occurring cross-linking agent that can react with amino acids or proteins containing residues with primary amine groups such as lysine, hydroxylysine or arginine. When sericin and genipin are combined, genipin cross-links the sericin creating a sticky glue, which can be used to adhere the plant wound dressing to the plant surface. It is contemplated that the either silk sericin or genipin may be either drops in the nanofiber body or in the core of the core-shell nanofiber. When the nanofiber mat is pressed onto the plant surface, sericin and genipin may be squeezed from some fibers so that genipin cross-links the sericin to form the adhesive material.

When the adhesive is added directly to the electrospinning solution containing the at least two different polymers, the adhesive component can be between 1% and 70%, more preferably 10% and 50%, by weight of the electrospinning solution.

In certain embodiments, the plant wound dressing also includes an agricultural anti-microbial agent, e.g., a bacteriocide or fungicide, or virucide, insecticide, nematicide, and/or miticide. Exemplary anti-microbial agents include, but are not limited to copper compounds (including water soluble copper compounds, inorganic copper compounds, and organic forms of copper compounds), phenylamides (metalaxyl, mefenoxam, among others), heteroaromatics (octhilinone, among others), methyl-benzimidazole-carbamate fungicides (carbendazim, thisbendazole, among others) and benzamides (zoxamide, among others), carboxamides (flutolanil, carboxin, oxycarboxin, boscalid, penthiopyrad, penflufen, among others), quinone outside inhibitors (azoxystrobin, pyraclostrobin, kresoxim-methyl, trifloxystrobin, famoxadone, fluoxastrobin, fenamidone, picoxystrobin, pyraoxystrobin, pyrametostrobin, among others), uncouplers of oxidative phosphorylation (fluazinam, among others), organotin compounds (fentin hydroxide, among others), anilino-pyrimidines (cyprodinil, pyrimethanil, among others), glucopyranosyl antibiotics (streptomycin, among others), tetracycline antibiotics (oxytetracycline, among others), quinolines (quinoxyfen, among others), phenylpyrroles (fludiosonil, among others), dicarboximides (iprodione, vinclozolin, among others), aromatic hydrocarbons that impact lipids and/or membrane synthesis (chloroneb, dicloran, quintozene, among others), heteroaromatics (etridiazole among others), carbamates (propamocarb, among others), and carboxylic acid amides (dimefhomorph, mandipropamid, among others), demethylation inhibitors (triforine, fenarimol, imazalil, triflumizole, difenoconazole, fenbuconazole, ipconazole, metconazole, myclobutanil, propiconazole, prothioconazole, tebuconazole, tetraconazole, triadimefon, tridimenol, among others), amides (piperalin, among others), hydroxyanilides (fenhexamid, among others), polyoxins (polyoxin, among others), benzo-thiodiazole (acibenzolar-s-methyl, among others), cyanoacetamide-oxime (cymoxanil, among others), phosphonates (fosetyl-Al, phosphorous acid and salts, among others), mineral oils, organic oils, potassium compounds, bicarbonates, inorganic salts (copper, copper salts, sulfur, among others), dithiocarbamates and related compounds (ferbam, mancozeb, maneb, metiram, thiram, ziram, among others), phthalimides (captan, folpet, among others), chloronitriles (chlrothalonil, among others), and guanidines (dodine, among others).

The plant wound dressing may consist solely of the above described biopolymer and second polymer; the biopolymer, second polymer, and base membrane; the biopolymer, second polymer, and adhesive; or the biopolymer, second polymer, adhesive, and base membrane; the biopolymer, second polymer and anti-microbial agent; the biopolymer, second polymer, base membrane and anti-microbial agent; the biopolymer, second polymer, adhesive and anti-microbial agent; or the biopolymer, second polymer, adhesive, base membrane and anti-microbial agent. Alternatively, the plant wound dressing may also optionally include additional components such as a crosslinking agent, a pigment, a filler, a perfume, a surfactant, a plant growth regulator, a plant nutrient, and/or an antistatic agent. A crosslinking agent can be used to crosslink and insolubilize. A pigment is used to color the dressing. Each of these other components is preferably used in an amount of 0.01% to 70% by weight in the dressing.

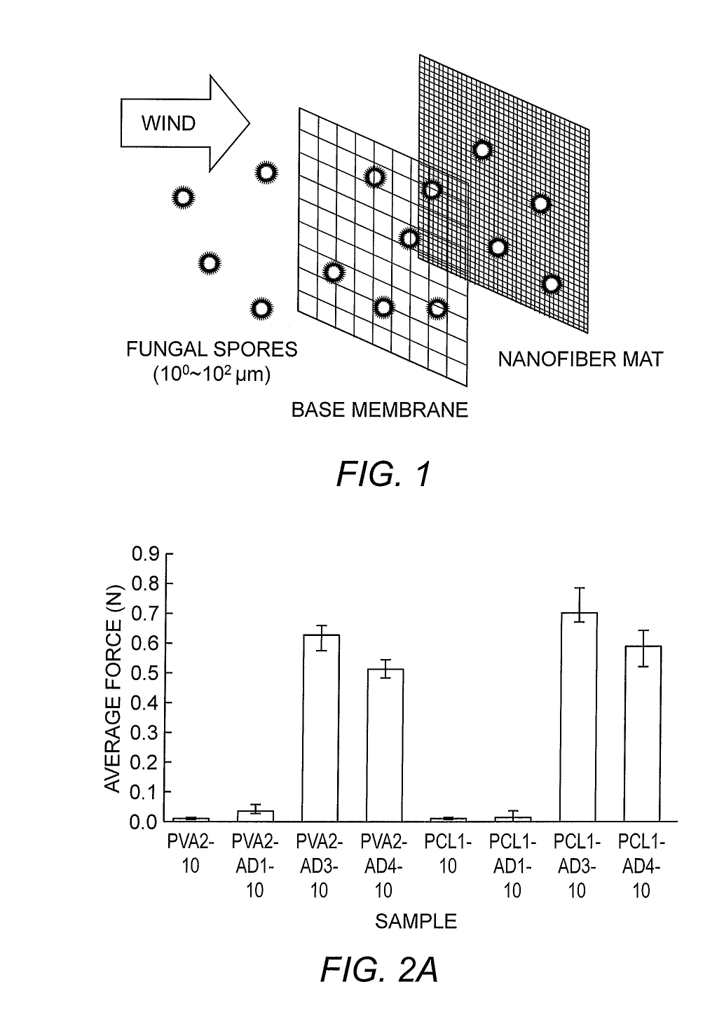

The plant wound dressing of this invention is microorganism impermeable. Impermeability of the dressing to microorganisms (e.g., bacteria and fungi) is due to the pore sizes of the nanofiber mats, which are configured to be sufficiently small to physically block microbial penetration. Fungal spores are approximately 1-20 μm in size. Similarly, bacterial cells generally range in size from 1 to 10 μm long, and from 0.2 to 1 μm wide. Therefore, while a microbe may be able to penetrate through a base membrane having a pore size in the range of 100 μm, fungal spores or bacterial cells will be intercepted by the nanofiber mat of the dressing (See FIG. 1), because the nanofiber mat has an average pore size of less than about 6 μm, preferably less than about 4 μm, more preferably less than about 2 μm, or most preferably less than or equal to 1 μm. Moreover, because the thickness of nanofiber mat is on the scale of 100 μm, it will be challenging for fungi germ tubes to penetrate through the dressing. In addition to microbes, the wound dressing will protect against insects and can also provide protection of plants against viral infection.

In addition to being microorganism impermeable, the plant wound dressing of the invention is permeable to both oxygen and carbon dioxide, i.e., the dressing is gas permeable. Air permeability can be assessed according to the ASTM D 737-75 (1980) Standard Test Method for Air Permeability of Textile Fabrics. This test measures the rate and volume of air flow through a fabric under a prescribed surface pressure differential. The higher the result reading, the more open the material is, thus allowing more air to pass through. Air flow rate and volume are an indication of fabric breathability. In certain embodiments, the plant wound dressing is also permeable to moisture.

Given that the plant wound dressing of this invention will be subject to varying environmental conditions, desirably the dressing can withstand strong wind conditions. In this respect, the wound dressing is characterized as having a peel force of between 0.0005 N and 0.1500 N, or more preferably between 0.0009 N and 0.10115 N; a normal specific adhesive energy of between 0.01 N/m and 50 N/m, or more preferably between 0.0225 N/m and 17.605 N/m; and/or a shear adhesive specific energy of between 1 N/m and 500 N/m, or more preferably between 1.386 N/m and 126.805 N/m. The strength of the wound dressing will be dependent upon the biopolymer, synthetic polymer and/or adhesive using the the production of the wound dressing. Of note, peeling specific energy is an important characteristic and the specific energies described herein are defined as the adhesion energy per unit interfacial area, with the units J/m² (N/m in the SI System of Units). The unit N/m also ascertains the fact that the specific adhesion energy can be considered as the surface tension. A number of different methods can be found for measuring the specific adhesive energy of nanofiber mats. Shear adhesion testing for dry adhesives is used for the characterization of directionally sensitive adhesives. The shaft-loaded blister test is used for measuring the debonding radius of electrospun fiber membranes. Adhesive forces between electrospun polymer fibers have been tested using industry standard peeling tests.

As exemplified herein, the biodegradable plant wound dressing of this invention is produced by blending at least two different polymers, wherein at least one of the polymers is a biopolymer, and electrospinning the blend to form a nanofiber mat. Any conventional electrospinning technique or derivative thereof, e.g., or solution blow spinning, can be used as long as the electrospraying conditions (e.g., the applied voltage, flow rate and nozzle-to-ground distance) provide an intact nanofiber structure that is microorganism impermeable. The instant plant wound dressing can be formed as a fabric, sheet or tape that can cut to size, or a pre-sized patch or bandage.

Vine Decline (esca) is one of the most important cases where a remedy for preventing vines from becoming infected and managing infected vines in an environmentally friendly way is urgently needed. The plant wood dressing described herein is a radically different approach for protecting plants against infection. Normal and shear specific adhesive energies of the exemplified nanofiber mats were measured, and the results showed that the mats could withstand strong wind without being blown off. On the other hand, the nanofiber mats possessed sufficient porosity for plant breathing. Therefore, the plant wound dressing of this invention can be applied directly on pruning locations or other injury or wound locations of vines and other plants to prevent plant disease. Accordingly, the present invention also provides a method for preventing microbial infection of a plant wound by applying to the wound the biodegradable plant wound dressing of this invention.

The method of this invention finds application in preventing infection by a number of wound transmissible pathogens including, but not limited to, esca which causes Vine Decline; Erwinia amylovora which causes fire blight; E. caratovora which causes soft rot; E. stewartii which causes Stewart's wilt; Nectria sp, Strumella sp., Eutypella sp., Cytospora sp., Sphaeropsis sp. which respectively cause fungal canker on shade trees, oaks, maples, spruce, and pines; and Pseudomonas syringae which causes bacterial canker on stone fruit trees.

The invention is described in greater detail by the following non-limiting examples.

### Example 1

### Materials and Methods

Materials.

Polyvinyl alcohol (PVA, MW=130 kDa, 99%+hydrolyzed, and MW-9 kDa, 80% hydrolyzed) and polycaprolactone (PCL, Mn=80,000) were obtained from Sigma-Aldrich. Solvents, formic acid, MW=46.03 Da, and acetic acid, MW=60.05 Da, were obtained from Sigma-Aldrich. Two different kinds of soy protein were used, one being water soluble, and the other one being water insoluble. Both the water-soluble soy protein, CLARISOY 100, and the water insoluble soy protein, PRO-FAM 955, were obtained from ADM Specialty Food Ingredients. PVAc (polyvinyl acetate) wood glue, water soluble adhesive SIMALFA 4574, repositionable glue, and pressure-sensitive adhesive MICRONAX 241-01 were obtained from Gamblin Artist's Colors, SIMALFA Water Borne Adhesives, Scaraperfect, and Franklin Adhesives, respectively. All adhesives are nontoxic in nature, with water-based MICRONAX 241-01 being FDA approved (compliant under 21CFR 175.105, 21CFR 176.170 and 21CFR 176.180). Non-ionic trisiloxane-(poly) ethoxylate surfactant SILWET L77 was provided by Momentive. TUCKS medicated cooling pads were obtained from Johnson & Johnson. These cooling pads, made from biodegradable rayon (regenerated cellulose) fabric, were used as a substrate on which nano-textured nanofiber mats were deposited. The specific adhesive energies of the prepared samples were measured on wooden surfaces. For this, balsa wood strips obtained from McMaster-Carr were used as a model material.

Solution Preparation.

Monolithic nanofibers of the two different types of soy protein were generated by electrospinning. For the water-soluble CLARISOY, aqueous solutions were prepared as follows. To prepare a homogeneous solution of soy protein/PVA with lower molecular weight PVA, a water and ethanol mixture was used as the base solvent. At the beginning, 4.5 grams each of deionized water and ethanol were mixed. Subsequently, 2.5 grams of PVA (MW-9 kDa, 80% hydrolyzed) was added to this solution and left on a hot plate at 95° C. under constant stirring for 4 hours. CLARISOY (0.5 grams) was added to the PVA solution and the resulting solution was left for 12 hours at 80° C. under constant stirring to provide a soy protein:PVA ratio of 16.7:83.3 (w/w). This solution was generally referred to as solution PVA1.

The adhesive solutions used for electrospraying were prepared as follows. FDA-approved MICRONAX adhesive (generally referred to AD1) was electrosprayed as received. In parallel, 4.0 grams of repositionable glue was dissolved in 5.0 grams of water-ethanol mixture (80:20 w/w) and stirred at 50° C. for 2 hours. This solution was generally referred to as solution AD2.

Higher molecular weight PVA, blends of PVA (MW=130 kDa, 99%+hydrolyzed), CLARISOY and different adhesives in water were also prepared. First, a 7.5% PVA solution was prepared by mixing 0.75 grams of PVA with 9.25 grams of deionized water and then leaving on a hot plate at 95° C. under vigorous stirring for 4 hours. Separately, a 10% water-soluble soy protein solution was prepared by mixing 1 gram of CLARISOY with 9 grams of deionized water and then leaving at 60° C. under constant stirring for 24 hours. After the solutions were cooled to room temperature, 2.5 grams of the 10% water-soluble soy protein solution was added to 5 grams of 7.5% PVA, resulting in a soy protein:PVA ratio of 40:60 (w/w). This solution was generally referred to as solution PVA2. Subsequently, three different adhesives were added to solution PVA2. One gram each of PVAc wood glue, SIMALFA 4574, and MICRONAX 241-01 were added to three separate solutions of PVA2 and the resulting solutions were generally referred to as PVA2-AD3, PVA2-AD4, and PVA2-AD1, respectively. The mixture solutions were stirred at room temperature for 1 hour. The solutions formed were homogeneous and there was no phase separation. Fully hydrolyzed PVA could not be electrospun and sporadic electrospraying of droplets was observed. To obtain nanofibers, 0.0425 grams (0.5% w/w) of non-ionic surfactant SILWET L77 was added to solutions PVA2-AD3, PVA2-AD4, and PVA2-AD1, which were then stirred for 5 minutes just before electrospinning.

Using water-insoluble soy protein, the following solutions were prepared. First, a 15% PCL solution was prepared by mixing 1.5 grams of PCL with 2.125 grams of formic acid and 6.375 grams of acetic acid (formic acid:acetic acid ratio of 25:75 v/v), and the solution was left for 24 hours on a hot plate at 50° C. under constant stirring. Obtaining bead-free continuous soy protein/PCL nanofibers was difficult when using formic acid as the only solvent. Hence, the formic acid:acetic acid mixture solution was used for preparing PCL solutions. Separately, an 18% water-insoluble soy protein solution was prepared by mixing 1.8 grams of water insoluble PRO-FAM 955 soy protein with 8.2 grams of formic acid and then stirring constantly for 24 hours at 60° C. After the solutions were cooled to room temperature, 4.17 grams of water insoluble soy protein solution was added to 5 grams of 15% PCL, resulting in a soy protein:PCL ratio of 50:50 (w/w). This solution was generally referred to as solution PCL1. Adhesive solutions AD1 and AD2 were used for electrospraying onto nanofibers electrospun from solution PCL1.

Similar to solution PVA2, three different adhesives were also added to solution PCL1. In particular, 1 gram each of PVAc wood glue, SIMALFA 4574, and MICRONAX 241-01 were added to three separate solutions of PCL1 and the resulting solutions were generally referred to as PCL1-AD3, PCL1-AD4, and PCL1-AD1, respectively. The solutions were stirred at room temperature for 1 hour. The solutions formed were homogeneous and there was no phase separation.

Fibers could not be electrospun from solutions prepared by adding repositionable glue to either the PVA-based PVA2 solution, or the PCL-based PCL1 solution. Since the adhesive AD2 was gelatinous in nature, a proper homogeneous blend solution of the adhesive with polymer and soy protein could not be formed. Due to this, electrospinning of soy protein/polymer solutions containing adhesive AD2 could not be conducted.

Electrospinning.

Monolithic fibers of soy protein/PVA and adhesive/soy protein/PVA were prepared using a standard electrospinning setup. The electrospinning technique is described in the art (see, e.g., Reneker, et al. (2007) Adv. Appl. Mech. 43-195; Reneker & Yarin (2008) Polymer 49:2387-2425; Greiner, et al. (2006) Appl. Microbiol. Biotechnol. 71:387-393; Yarin, et al. (2007) J. Mater. Chem. 17:2585-2599; Yarin (2011) Polym. Adv. Technol. 22:310-7).

Randomly-oriented nanofibers of solutions PVA1, PVA2, PVA2-AD1, PVA2-AD3, and PVA2-AD4 were collected on the rayon pads kept on an aluminum foil for 10 minutes while keeping the flow rate at 0.3-0.5 mL/h. A 15-18 kV positive voltage was applied to the solutions and the distance between the tip of the needle and the rayon pad was about 10-15 cm while keeping the relative humidity at 30%. Electrospinning was done using an 18 gauge needle with an outer diameter of 1.27 mm and an inner diameter of 0.838 mm. Direct electrospinning of PCL-based solutions created fluffy nanofibers and caused delamination of the fibermat from the rayon pad. To prevent delamination and enhance the adherence of the electrospun nanofiber mat to the rayon pad, the adhesive was initially electrosprayed at 0.5 mL/h and 15 kV positive voltage for 5 minutes onto bare rayon pads. The initial adhesive electrosprayed was chosen to be the same as the adhesive in the respective solution used for electrospinning. Only for pure soy protein/PCL fibers, adhesive solution AD1 was used. This was done because, amongst the four adhesives used, this one possessed the minimum specific adhesive energy and is FDA approved. Immediately after electrospraying, electrospinning was conducted onto the pads for 10 minutes at a flow rate of 0.3-0.5 mL/h and a positive voltage of 14-16 kV was applied to the solutions. The distance between the tip of the needle and the substrate and the relative humidity were the same as for the PVA-based solutions.

Electrospinning was conducted for 10 minutes for solutions PVA1, PVA2, PVA2-AD1, PVA2-AD3, and PVA2-AD4 and the samples were generally referred to as PVA1-10, PVA2-10, PVA2-AD1-10, PVA2-AD3-10, and PVA2-AD4-10, respectively. Additionally, to measure the dependence of the specific adhesive energy on the electrospinning time, solution PVA2-AD3 was electrospun for 5 minutes, 10 minutes and 20 minutes onto separate rayon pads. Solution PVA2-AD3 was chosen for this test because PVAc wood glue (AD3) was found to be the strongest among all the adhesives. These samples were generally referred to as PVA2-AD3-5, PVA2-AD3-10 and PVA2-AD3-20. For electrospinning of soy protein/PCL fibers, the adhesive solution AD1 was initially electrosprayed for 5 minutes, followed by electrospinning of solution PCL1 for 10 minutes. This sample was generally referred to as PCL1-10. Similarly, solutions AD1, AD3, and AD4 were electrosprayed for 5 minutes followed by electrospinning of PCL1-AD1, PCL1-AD3, and PCL1-AD4 on the respective electrosprayed rayon pads. These samples were generally referred to as PCL1-AD1-10, PCL1-AD3-10, and PCL1-AD4-10. To measure the dependence of the specific adhesive energy on the electrospinning time, the PCL-AD3 solution was electrospun onto the AD3-electrosprayed rayon pad for 5 minutes, 10 minutes, and 20 minutes. The initial electrospraying time was kept constant at 5 minutes. These samples were generally referred to as PCL1-AD3-5, PCL1-AD3-10, and PCL1-AD3-20, respectively. The compositions of the different samples are listed in Table 2 and the time of spinning and resulting average fiber diameter of the samples is provided in Table 3.

TABLE 2

| | Polymer | | Soy Protein | | Adhesive | |
|---|---|---|---|---|---|---|
| Sample | Type | Conc^{a} | Type | Conc^{a} | Type | Conc^{a} |
| PVA1-10 | PVA | 20.83 | CLARISOY | 4.17 | None | None |
| | (9 kDa) | | | | | |
| PVA2-10 | PVA | 5 | CLARISOY | 3.33 | None | None |
| | (130 kDa) | | | | | |
| PVA2-AD1-10 | PVA | 4.41 | CLARISOY | 2.94 | MICRONAX | 11.76 |
| | (130 kDa) | | | | | |
| PVA2-AD3-5 | PVA | 4.41 | CLARISOY | 2.94 | PVAc | 11.76 |
| | (130 kDa) | | | | | |
| PVA2-AD3-10 | PVA | 4.41 | CLARISOY | 2.94 | PVAc | 11.76 |
| | (130 kDa) | | | | | |
| PVA2-AD3-20 | PVA | 4.41 | CLARISOY | 2.94 | PVAc | 11.76 |
| | (130 kDa) | | | | | |
| PVA2-AD4-10 | PVA | 4.41 | CLARISOY | 4.17 | SIMALFA | 11.76 |
| | (130 kDa) | | | | | |
| SPv01 | PVA | 20.83 | CLARISOY | 4.17 | MICRONAX | Electro |
| | (9 kDa) | | | | | spray |
| SPv02 | PVA | 20.83 | CLARISOY | 8.18 | Reposi- | Electro |
| | (9 kDa) | | | | tional | spray |
| | | | | | Glue | |
| PCL1-10 | PCL | 8.18 | PRO-FAM | 7.37 | None | None |
| | | | 955 | | | |
| PCL1-AD1-10 | PCL | 7.37 | PRO-FAM | 7.37 | MICRONAX | 9.83 |
| | | | 955 | | | |
| PCL1-AD3-5 | PCL | 7.37 | PRO-FAM | 7.37 | PVAc | 9.83 |
| | | | 955 | | | |
| PCL1-AD3-10 | PCL | 7.37 | PRO-FAM | 7.37 | PVAc | 9.83 |
| | | | 955 | | | |
| PCL1-AD3-20 | PCL | 7.37 | PRO-FAM | 7.37 | PVAc | 9.83 |
| | | | 955 | | | |
| PCL1-AD4-10 | PCL | 7.37 | PRO-FAM | 7.37 | SIMALFA | 9.83 |
| | | | 955 | | | |
| SPc01 | PCL | 8.18 | PRO-FAM | 8.18 | MICRONAX | Electro |
| | | | 955 | | | spray |
| SPc02 | PCL | 8.18 | PRO-FAM | 8.18 | Reposi- | Electro |
| | | | 955 | | tional | spray |
| | | | | | Glue | |

^{a}Percent weight in solution.

TABLE 3

| | Time of | Avg. Fiber |
|---|---|---|
| | Spinning | Diameter |
| Sample | (minutes) | (nm) |
| PVA1-10 | 10 | 713 |
| PVA2-10 | 10 | 728 |
| PVA2-AD1-10 | 10 | 805 |
| PVA2-AD3-5 | 5 | 761 |
| PVA2-AD3-10 | 10 | 766 |
| PVA2-AD3-20 | 20 | 769 |
| PVA2-AD4-10 | 10 | 782 |
| SPv01 | 10 | 716 |
| SPv02 | 10 | 714 |
| PCL1-10 | 10 | 987 |
| PCL1-AD1-10 | 10 | 1018 |
| PCL1-AD3-5 | 5 | 999 |
| PCL1-AD3-10 | 10 | 1004 |
| PCL1-AD3-20 | 20 | 1002 |
| PCL1-AD4-10 | 10 | 1009 |
| SPc01 | 10 | 1016 |
| SPc02 | 10 | 1015 |

Electrospraying Adhesive Solutions Onto Soy Protein/PVA and Soy Protein/PCL Fiber Mats.

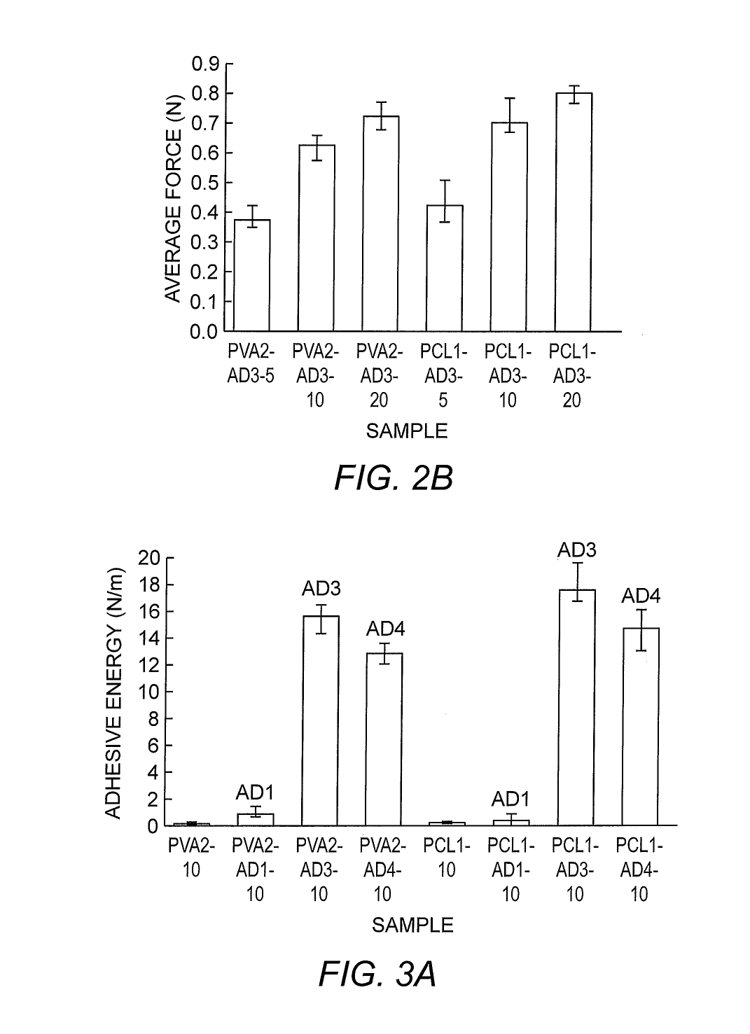

Adhesive solutions AD1 and AD2 were electrosprayed onto samples PVA1-10 and PCL1-10. Electrospraying of MICRONAX 241-01 (AD1) and the repositionable glue (AD2) were carried out on separate samples of PVA1-10 and PCL1-10 for 10 minutes and the samples with the adhesives were generally referred to as samples SPv01 and SPv02 for the soy/PVA fiber mats, and SPc01 and SPc02 for the soy/PCL fiber mats, respectively. The flow rate was maintained at 0.5 mL/h, and a 15 kV positive voltage was applied to the adhesive solutions. The distance between the tip of the needle and the mat was about 10 cm. It should be emphasized that for electrospraying repositionable glue (AD2), only adhesive droplets from the solution reached the nanofiber mat. For SPv02, with both soy protein and PVA being water soluble, water droplets from the adhesive reaching the nanofiber mat would have dissolved the polymer and the fiber structure would have been destroyed. By controlling the electrospraying conditions (the applied voltage, flow rate and nozzle-to-ground distance), the nanofiber structure was kept intact after electrospraying the repositionable adhesive (AD2). This was verified by the fact that only small adhesive droplets were seen on SPv02 samples after electrospraying. As such, it was concluded that the water from the adhesive solution evaporated and did not reach the fiber mat. Such controlled conditions could not be obtained for electrospraying of adhesive AD1, and samples SPv01 had large droplets after electrospraying. Not all the water evaporated and some of it reached the fiber mat. A schematic of electrospraying adhesives is shown in FIG. 2. The compositions of the different samples prepared by electrospraying adhesives onto electrospun nanofiber mats are listed in Table 2.

180° Peeling Tests.

The normal adhesion force of prepared nanofiber mats with adhesives was measured in mechanical peeling tests. In general, 1 kg of weight was gently rolled 20 times on a 6 cm×2 cm sample placed on a balsa wood strip (10 cm×2.6 cm) right after electrospinning. Then, a 180° peel test was performed using a 100 N capacity Instron machine (model 5942). The upper and lower ends of the samples were clamped by Instron's pneumatic grips. The upper end was stretched at a constant rate of 10 mm/min, while the lower end was kept at its initial position. The peeling tests were conducted until the entire sample was peeled off the balsa wood strip. For the repositionable glue electrosprayed onto the nanofiber mat (samples SPv02 and SPc02), the same sample was pressed and the peeling test was done several times consecutively. SPv02 was tested in this manner seven times. The stickiness of SPc02 was lost after three trials, and hence the latter sample could not be tested more than three times. For the pressure sensitive MICRONAX adhesive samples (samples SPv01 and SPc01), the peeling test was conducted for different applied weights on samples of 1 kg, 5 kg, and 11.5 kg. Thus, the pressure applied to the samples changed from 0.83 kPa (for 1 kg) to 4.17 kPa (for 5 kg) and finally to a maximum of 9.55 kPa (for 11.5 kg).

Dead Weight Test.

The specific shear adhesion energy was measured using the ‘dead weight’ test, which is a standard test for measuring the specific adhesion energy of nanofiber mats. A sample (2.3 cm×5 cm) was adhered to the balsa wood strip by loading a 1 kg weight for 1 minute. The edge of sample was connected to an empty container through the pulley. After the weight had been removed, water was slowly poured into the container until the sample delaminated from the wooden strip. The specific shear adhesion energy was calculated from the total weight of water in the container when delamination occurred.

Optical Characterization.

All optical images were taken using an OLYMPUS BX-51 optical microscope. SEM images and EDX analysis were obtained using a HITACHI S-3000 N.

### Example 2

### Monolithic Soy Protein/PVA and Soy Protein/PCL Nanofiber Mats

Solutions PVA1, PVA2 and PCL1 were electrospun resulting in soy protein/PVA and soy protein/PCL nanofibers (both on rayon substrate). Energy dispersive X-ray (EDX) spectra of these nanofibers were obtained to detect the presence of soy protein in the as-spun monolithic fibers. Soy protein contains sodium (Na), phosphorus (P), and sulfur (S), which are considered unique markers for this protein (Sinha-Ray, et al. (2011) Biomacromolecules 12:2357-63). The percentage content of different elements of the EDX spectra of monolithic soy protein/PVA and soy protein/PCL nanofibers obtained by electrospinning solutions PVA1, PVA2 and PCL1 is shown in Table 4 and the values are in good agreement with the soy content in soy protein/nylon six fibers (Sinha-Ray, et al. (2011) Biomacromolecules 12:2357-63).

TABLE 4

| | Weight % | | |
|---|---|---|---|
| Element | Sample PVA1-10 | Sample PVA2-10 | Sample PLC-10 |
| Carbon | 82.95 | 73.62 | 85.16 |
| Oxygen | 16.67 | 25.55 | 14.18 |
| Sodium | 0.2 | 0.45 | 0.17 |
| Phosphorus | 0.06 | 0.1 | 0.29 |
| Sulfur | 0.13 | 0.28 | 0.20 |
| Total | 100.1 | 100.0 | 100.0 |

The weight % of Na, P and S is higher for sample PVA2-10 than for sample PVA1-10 as the soy protein/PVA ratio for sample PVA2-10 is 40/60 (w/w) as compared to 16.7/83.3 (w/w) for sample PVA1-10. In addition, different soy proteins possess different contents of Na, P and S. Water-soluble CLARISOY has a higher percentage of Na as compared to P and S, whereas water-insoluble PRO-FAM 955 has a higher percentage of P and S as compared to Na (cf. Table 4).

### Example 3

### Electrospinning of Water-Soluble Adhesive/Soy Protein/PVA and Water-Insoluble Adhesive/Soy Protein/PCL Solutions

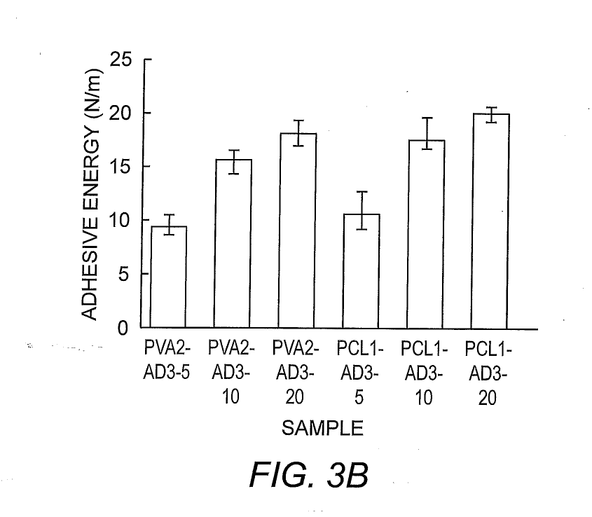

Normal specific adhesive energy of mats composed of electrospun soy protein/PVA and soy protein/PCL fibers containing PVAc wood glue, samples PVA2-AD3-10 and PCL1-AD3-10, respectively, was determined. The fiber morphology was not as uniform as it was for pure soy protein/PVA or pure soy protein/PCL fibers electrospun from solutions PVA2 and PCL1. The electrospun fibers containing adhesives appeared beaded at different places along the fiber length due to the presence of the adhesives in the solutions. However, the fiber distribution on the rayon mat was similar to the soy protein/PVA and soy protein/PCL fibers. Samples PVA2-AD1-10, PVA2-AD4-10, PCL1-AD1-10, and PCL4-AD1-10 possessed similar fiber morphology to samples PVA2-AD3-10 and PCL1-AD3-10. Prior electrospraying of adhesives was required for the PCL-based solutions. This is because the soy protein/PCL fibers or the adhesive/soy protein/PCL fibers were rather fluffy and did not reveal good adherence to the rayon pads, unlike the adhesive/soy protein/PVA fibers. This also caused some delamination of the adhesive/soy protein/PCL fibers, where at the end of the peeling test, some of the electrospun adhesive/soy protein/PCL fibers delaminated from the rayon pads and stuck to the balsa wood strip. This delamination effect was observed irrespective of the adhesive used. To avoid delamination, the adhesives were first electrosprayed on bare rayon pads for 5 minutes. Subsequently, different samples of adhesive/soy protein/PVA and adhesive/soy protein/PCL fiber mats were pressed onto balsa wood strips, and peeling tests were conducted after rolling a 1 kg weight 20 times on the samples as previously described herein. To achieve accurate results, 10 samples of each kind were tested. FIGS. 2A and 3A show the average peel forces and specific adhesive energy for the different adhesive/soy protein/PVA and adhesive/soy protein/PCL fibers compared with those of the pure soy protein/PVA (sample PVA2-10) and the pure soy protein/PCL (sample PCL1-10) nanofiber mats. For either of the two types of soy protein/polymer fiber mat, the peel force was almost negligible for the fiber mats without adhesive (samples PVA2-10 and PCL1-10). The peel force was the highest for PVAc wood glue (samples PVA2-AD3-10 and PCL1-AD3-10), followed by SIMALFA adhesive (samples PVA2-AD4-10 and PCL1-AD4-10), and the lowest for the FDA adhesive (samples PCL1-AD1-10 and PCL1-AD1-10). The peel force for the soy protein/PCL fibers with adhesives was more than the peel force for the corresponding soy protein/PVA fibers with the same adhesive (Table 5). This is because the adhesive was initially electrosprayed for 5 minutes on the bare rayon pads prior to electrospinning of the PCL-based adhesive solutions. Hence, the total adhesive on the rayon pad was composed of both the electrosprayed adhesive and the electrospun nanofibers with adhesives for the PCL-based samples was higher as compared to the adhesive content of the only-electrospun fibers with adhesives for the PVA-based samples.

TABLE 5

| | | Normal Specific |
|---|---|---|
| | Peel Force | Adhesive Energy |
| Sample | (N) | (N/m) |
| PVA2-10 | 0.0009 | 0.0225 |
| PVA2-AD1-10 | 0.0062 | 0.155 |
| PVA2-AD3-10 | 0.6290 | 15.725 |
| PVA2-AD4-10 | 0.5151 | 12.878 |
| PLC1-10 | 0.0025 | 0.0625 |
| PLC1-AD1-10 | 0.0144 | 0.36 |
| PLC1-AD3-10 | 0.7042 | 17.604 |
| PLC1-AD4-10 | 0.5916 | 14.79 |

The normal specific adhesive energy, Gn of the adhesive was calculated as Gn=F/2W (Eqn 1), where F is the peel force and W is the sample width. Eqn 1 is derived using the fact that the work of the peel force is distributed between elastic storage and surface energy, as is usually done for adhesive joints when methods of fracture mechanics are applied. Here, the sample width W was 2 cm for all samples. The thickness of the sample, t, varied with different types of fiber mats. The thickness, t, of the sample was found by measuring the distance between the top layer of the fibers and the base substrate of the rayon pad using an OLYMPUS BX-51 optical microscope. This was done by focusing first on the upper-most nanofiber layer and then on the bottom-most nanofiber located on the rayon pad substrate. The thicknesses of the fiber mats for the PVA-based solutions were found to be the same for 10 minutes of electrospinning and did not depend on the adhesive present in the solution. In other words, it was concluded that the fiber mat thickness was determined by PVA and soy protein alone and was independent of the nature of the adhesive. The thickness, t, was 280 mm for samples PVA2-10, PVA2-AD1-10, PVA2-AD3-10, and PVA2-AD4-10. Due to the initial electrospraying of adhesives for the PCL-based solutions, the thickness of the samples varied for the different adhesives. The thicknesses of the samples were 375 mm, 380 mm, 310 mm, and 315 mm for PCL1-10, PCL1-AD1-10, PCL1-AD3-10, and PCL1-AD4-10, respectively. Electrospraying of adhesive AD1 led to formation of larger droplets on the bare rayon pad, thereby increasing the entire sample thickness significantly as compared to adhesives AD3 and AD4, which formed fine small droplets.

The normal adhesive energies, Gn, of the different adhesives are listed in Table 5. The specific adhesive energy should be considered as a material property for samples electrospun for the same time. Indeed, the electrospinning time controls the mat porosity and thus the number of contacts with the underlying surface, which affects the specific adhesive energy together with the fiber and underlying materials. Accordingly, it was found that the specific adhesive energies obtained for the same adhesive using either soy protein/PVA or soy protein/PCL are actually in the same range (cf. FIG. 6 and Table 5). Due to the presence of the initial electrosprayed layer of adhesive, the peel forces were higher for soy protein/PCL adhesive fibers than for soy protein/PVA fibers. Accordingly, the specific adhesive energies were also slightly higher for soy protein/PCL adhesive fibers. Using Eqn (1), the normal specific adhesive energies of the different samples were found to be in the same range.

The effect of electrospinning time on normal specific adhesive energy of fiber mats was also assessed. As mentioned above, the electrospinning time determines the mat porosity and thus the number of contacts with the underlying surface, which, in turn, affects the specific adhesive energy along with the fiber and underlying materials. Solutions PVA2-AD3 and PCL1-AD3 were electrospun for 5 minutes, 10 minutes, and 20 minutes to study the dependence of the normal specific adhesive energy of the fiber mats on electrospinning time. As discussed, fibers containing adhesive AD3, PVAc wood glue, possessed the maximum specific adhesive energy. Hence, the strongest adhesive was chosen to study the effect of electrospinning time on the normal specific adhesive energy. Although the thickness of the fiber mat increased with increasing electrospinning time, it did not increase proportionally to time. In other words, the thickness of fiber mat after 10 minutes of electrospinning was not doubled compared to that obtained after 5 minutes of electrospinning. Similarly, after 20 minutes of electrospinning, the thickness was neither four times that after 5 minutes of electrospinning, nor double that in 10 minutes of electrospinning. This demonstrates that with longer electrospinning time, there are more fibers in the same layer and the distance between neighboring fibers, or the pore size, is reduced. This increases the number of contacts of nanofibers with the underlying surface, and thus increases the peel force and the adhesive strengths of the samples. The thicknesses of the fiber mats measured using the optical microscope were 170 mm, 280 mm, 340 mm, 195 mm, 310 mm, and 370 mm for PVA2-AD3-5, PVA2-AD3-10, PVA2-AD3-20, PCL1-AD3-5, PCL1-AD3-10, and PCL1-AD3-20, respectively. The thickness of the PCL-based fiber mat was larger than that of the PVA-based fiber mat due to the prior electrospraying of adhesive on the bare rayon pad.

FIGS. 2B and 3B show the peel forces and specific adhesive energy of samples PVA2-AD35, PVA2-AD3-10, PVA2-AD3-20, PCL1-AD3-5, PCL1-AD3-10, and PCL1-AD3-20. The peel force and the specific adhesive energy increases with increasing electrospinning time for both PVA- and PCL-based samples.

Shear specific adhesive energy of fiber mats was assessed by dead weight tests with the pure soy/polymer fiber mats and adhesive/soy/polymer fiber mats (Table 6).

TABLE 6

| | | Shear Adhesive |
|---|---|---|
| | Dead Weight | Specific Energy |
| Sample | (g) | (N/m) |
| PVA2-10 | 6.5 | 1.386 |
| PVA2-AD1-10 | 29.8 | 6.355 |
| PVA2-AD3-10 | 467.2 | 99.635 |
| PVA2-AD4-10 | 344.5 | 73.468 |
| PLC1-10 | 14.3 | 3.049 |
| PLC1-AD1-10 | 54.1 | 11.537 |
| PLC1-AD3-10 | 594.6 | 126.805 |
| PLC1-AD4-10 | 405.6 | 86.498 |

From the weight measurements, the shear specific adhesive energy was calculated as Gsh=mg/2W (Eqn 2), where m is the mass of water in the container when the sample delaminated, g is gravity acceleration and W is the sample width. All dead weight tests were conducted with 2.3 cm×5 cm samples, so the sample width was constant at 2.3 cm. Eqn (2) is derived similarly to Eqn (1). The shear specific adhesive energies, Gsh, measured with different adhesives are listed in Table 6. Similar to the normal specific adhesive energy, the shear specific adhesive energy obtained for the same adhesive using either soy protein/PVA or soy protein/PCL are in the same range (cf. Table 6). Due to the presence of the initial electrosprayed layer of adhesive, the weight required to delaminate the samples was higher for soy protein/PCL adhesive fibers than for soy protein/PVA fibers. Since the area of the samples was the same for all the dead weight test samples, the higher weight for the adhesive/soy/PCL samples resulted in higher adhesive forces. Furthermore, similar to the results obtained in the normal adhesion test, the PVAc wood glue was the strongest and revealed the highest specific adhesive energy among the other adhesives tested. A comparison of the results in Tables 5 and 6 shows that the shear specific adhesive energies can be significantly higher (typically by one or even two orders of magnitude) than the normal specific adhesive energies of the corresponding fiber samples.

### Example 4

### Electrospraying Adhesive onto Soy Protein/PVA and Soy Protein/PCL Nanofiber Mats

Image analysis of a pristine soy protein/PVA fiber mat, sample PVA1-10, shows thicker black filaments, which are the background rayon fiber strands and adhesive barrel-shaped drops on the soy protein/PVA nanofibers after sample PVA1-10 had been electrosprayed by adhesive AD2 for 10 minutes. Similarly, electrospraying of adhesives AD1 and AD2 was conducted for 10 minutes onto sample PCL1-10. The electrosprayed droplets have diameters in the range 1-10 mm. It should be emphasized that the adhesive droplets are located on the nanofibers and do not block the fiber pores.

Adhesive AD1 is a pressure-sensitive adhesive and the normal specific adhesive energies of samples SPv01 and SPc01 were tested for different applied pressures. The adhesive droplets were smeared onto the soy protein/PVA and soy protein/PCL nanofiber mats. SEM images of the soy protein/PVA fibers before and after the 180° peeling test of samples SPv01 and SPv02 were compared. Morphologically, for lower load (1 kg), the overall nanofiber structure remained intact even after the peeling test. However, on application of a higher load (11.5 kg), the adhesive was completely smeared and the pore structure was lost with dramatically reduced pores. For reusability of the prepared nanofiber patches using repositionable adhesive AD2, (samples SPv02 and SPc02), the normal specific adhesive energies of the samples were tested by repeating the loading-peeling test on the same sample. On repeating the peeling test on the same sample, some of the adhesive droplets coalesced. After repeating the peeling test on the same sample seven times for sample SPv02, the adhesive drops were completely smeared. However, the pores, though diminished, were still not completely blocked. SEM images of adhesives electrosprayed on separate samples of PCL-10 were also analyzed. The peeling test for the same sample of SPc02 could be done only three times. This is because at the end of the third test, there was no adhesive remaining in the fiber mats and they could not be stuck onto the balsa wood strip again.

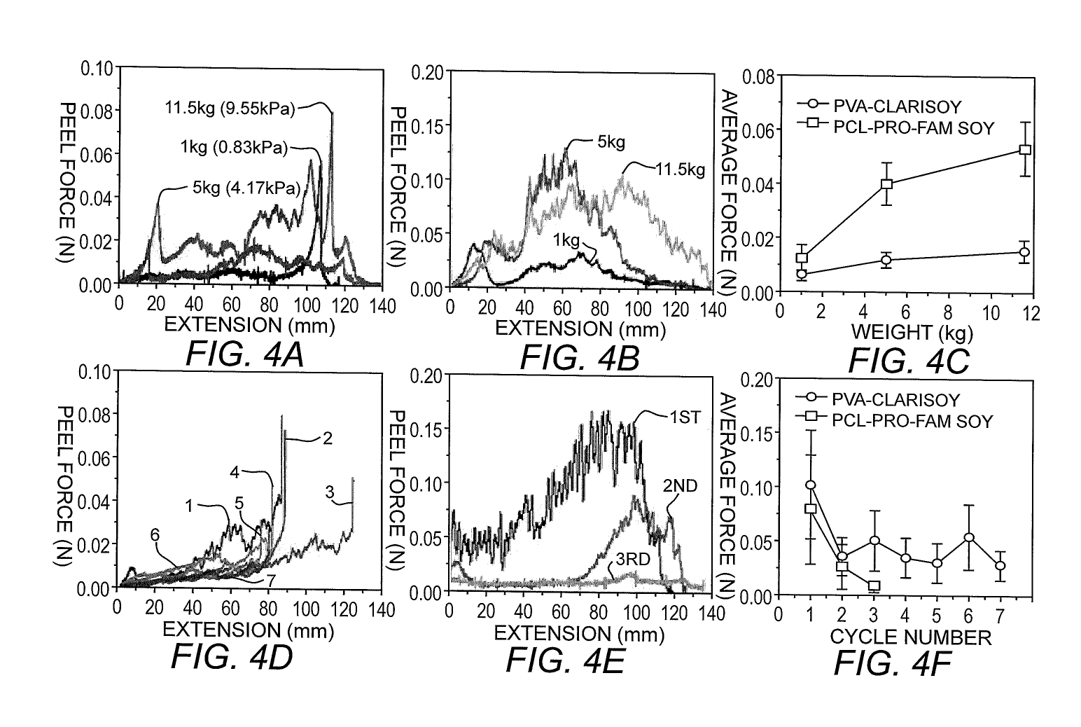

The average peel force values for the 180° peeling tests of several samples are shown in FIGS. 4A-4F. For pressure-sensitive adhesive AD1, increasing pressure leads to an increase in the average peel force (FIG. 4A for SPv01, and FIG. 4B for SPc01) required to peel the samples off. For repositionable adhesive AD2 in consecutive peeling tests (seven for SPv02, and three for SPc02 on the same sample) the results are shown in FIG. 4D and FIG. 4E, respectively. The peel force decreases from the maximal value after the first peeling test (from 0.1 N to 0.03 N), and thereafter remains in the range of 0.02 N to 0.05 N (Table 7).

TABLE 7

| | | | Normal Specific |
|---|---|---|---|
| | | Peel Force | Adhesive Energy |
| Sample | Cycle | (N) | (N/m) |
| SPv02 | 1 | 0.10115 | 2.53 |
| | 2 | 0.03537 | 0.89 |
| | 3 | 0.05008 | 1.25 |
| | 4 | 0.03462 | 0.87 |
| | 5 | 0.03022 | 0.76 |
| | 6 | 0.05442 | 1.36 |
| | 7 | 0.02774 | 0.69 |
| SPc02 | 1 | 0.07901 | 1.65 |
| | 2 | 0.02624 | 0.55 |
| | 3 | 0.00844 | 0.18 |

The normal specific adhesive energy, Gn, of the adhesives was calculated using Eqn (1). The thicknesses of the adhesive droplet layers on the soy protein/PVA nanofiber mats were as follows: for SPv01 the thickness was 92 mm, for SPv02 the thickness was 27.7 mm, for SPc01 the thickness was 303.3 mm, and for SPc02 the thickness was 343.8 mm. The sprayed adhesive layer was thicker for the soy protein/PCL samples as compared to the soy protein/PVA samples. This is due to the different material properties of the fibers. For hydrophobic PCL, the water-soluble adhesive droplets were hanging from the fiber surfaces, whereas for hydrophilic PVA, the adhesive droplets were spread almost uniformly along the entire surface of the fibers. The adhesive energies along with the corresponding peel forces measured for different pressures applied on SPv01 and SPc01 samples and in consecutive peeling tests of the same samples of SPv02 and SPc02 are listed in Tables 8 and 7, respectively.

TABLE 8

| | | | Normal Specific |
|---|---|---|---|
| | Applied | Peel Force | Adhesive Energy |
| Sample | Pressure | (N) | (N/m) |
| SPv01 | 0.83 | 0.00565 | 0.14 |
| | 4.17 | 0.01142 | 0.29 |
| | 9.55 | 0.01508 | 0.38 |
| SPc01 | 0.83 | 0.01188 | 0.25 |
| | 4.17 | 0.03982 | 0.83 |
| | 9.55 | 0.05312 | 1.11 |

FIGS. 4C and 4F show the difference in the effect of the same adhesive electrosprayed on two different types of fiber mats. This can be explained as follows. Soy protein/PVA fibers (sample PVA1-10) are water soluble and hydrophilic in nature. The electrospraying conditions of the adhesives AD1 and AD2 were different, with AD1 producing large droplets and AD2 producing smaller ones. Accounting for the fact that the large droplets of AD1 contained more water, this implies that impinging of these droplets onto PVA1-10 dissolved some of the fibers. The fiber morphology was lost in these places and adhesiveness was not found, accordingly. Soy protein/PCL sample (PCL1-10) is insoluble in water. Hence, the size of the droplets did not affect the fibers and the adhesive drops were still located on the fiber mat. Therefore, with the pressure-sensitive FDA-approved adhesive AD1, the peel force was higher for sample SPc01 as compared to sample SPv01 (FIG. 4C and Table 8). Due to an increase in the thickness of the adhesive layer for SPc01, there was no significant increase in the normal specific adhesive energy of the adhesive AD1 as compared to that of adhesive AD2.

The adhesive droplets of AD2 reaching the soy protein/PVA mat were small and contained no water. Hence, the fiber morphology of the sample SPv02 remained unchanged. On the other hand, PCL is hydrophobic, and the small adhesive droplets could be easily detached from the sample (sample SPc02). Hence, on repetitive peeling of the same sample of SPc02, the adhesive droplets no longer remained on the fiber surface and almost no adhesive remained after peeling the same sample thrice (FIG. 4F).

### Example 5

### Shear Adhesion Tests

Tables 9 and 10 show the results of the dead weight test for the different samples prepared by electrospraying adhesives AD1 and AD2, respectively. The shear specific adhesive energy was calculated using Eqn (2), with the samples having the same dimensions of 2.3 cm×5 cm. The shear specific adhesive energy depends on both the type of the fibers and the adhesive.

TABLE 9

| | | | Shear Specific |
|---|---|---|---|
| | Applied | Dead Weight | Adhesive Energy |
| Sample | Pressure | (g) | (N/m) |
| SPv01 | 0.83 | 37.4 | 7.98 |
| | 4.17 | 108.8 | 23.2 |
| | 9.55 | 146.0 | 31.1 |
| SPc01 | 0.83 | 70.6 | 15.1 |
| | 4.17 | 183.5 | 39.1 |
| | 9.55 | 289.3 | 72.4 |

TABLE 10

| | | | Shear Specific |
|---|---|---|---|
| | | Dead Weight | Adhesive Energy |
| Sample | Cycle | (g) | (N/m) |
| SPv02 | 1 | 120 | 25.6 |
| | 2 | 49.7 | 10.6 |
| | 3 | 25.4 | 5.43 |
| | 4 | 12.4 | 2.65 |
| | 5 | 8.90 | 1.9 |
| | 6 | 14.3 | 3.05 |
| SPc02 | 1 | 55.3 | 11.8 |
| | 2 | 41.5 | 8.85 |
| | 3 | 36.4 | 7.75 |

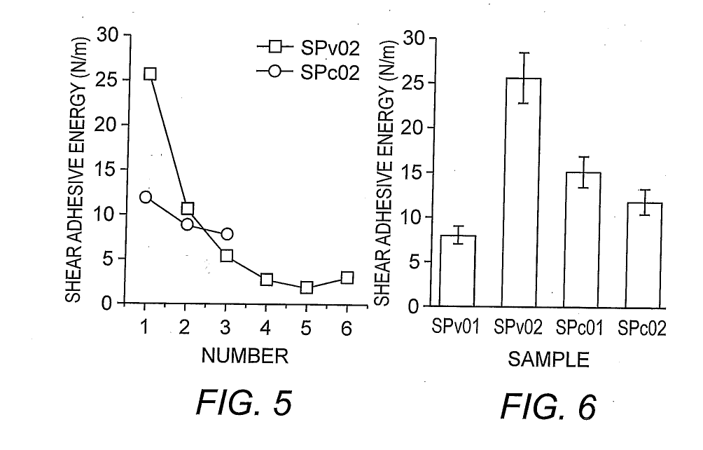

Comparing between samples SPc01 and SPv01 in FIG. 5, it is seen that the sprayed AD1 solution adhered better on PCL fibers than on PVA fibers. This is because the electrosprayed adhesive AD1 produced large droplets that dissolved some of the soy/PVA fibers, whereas soy/PCL fibers, being insoluble in water, remained intact. With the adhesive solution AD2, sample SPv02 showed the best shear specific adhesive energy in the first trial (see FIG. 5). Since the adhesive AD2 is repositionable, the same sample was used for repeated tests and the specific adhesive energy was found to drop dramatically in these tests. This happened because most of the sprayed adhesive was detached from the fiber surface after the first test. As mentioned above, PCL is not a water-soluble polymer, so water squeezed from the adhesive onto the fiber mat does not pose a problem. The investigation of the effect of glue on the shear specific adhesive energy of samples SPc01 and SPc02 (see FIG. 5) revealed that AD1 possesses a higher specific adhesive energy than AD2. The reason for the reduced specific adhesive energy of sample SPv01 as compared to SPv02 is related to the fact that the PVA fibers can be dissolved by large electrosprayed droplets of AD1. This demonstrates that the shear specific adhesive energy of composite depends on a proper combination of the fiber and adhesive pair more than on the ability of the adhesive itself. The average value of the shear specific adhesive energy for the developed patches is in the range of 7-25 N/m. This is significantly smaller than previously reported values (Najem, et al. (2014) Langmuir 30:10410-8) where the specific adhesive energy of pure nylon fibers was measured. It should be emphasized that Najem, et al. employed aligned 50 nm nanofibers and reported 2.7 times stronger adhesion than that of a gecko foot.

### Example 6

### Compostability Tests of the Developed Nanofiber Patches

Compostability tests were conducted to test the longevity of the developed patches under atmospheric conditions. SEM images of the monolithic soy protein/PVA fibers (sample PVA2-10) and soy protein/PCL fibers (sample PCL1-10) were taken immediately after electrospinning, 30 days after the sample was left open at room temperature and humidity, and after a water droplet was gently placed on the fiber mat. No degradation in the fiber structure was seen for sample PVA2-10 when left under open atmospheric conditions. However, with both the soy protein (CLARISOY) and PVA being water soluble, the entire fiber structure was lost on addition of a water droplet. With soy protein (PRO-FAM 955) and PCL, both being water insoluble, the fibers remained intact under the atmospheric conditions, as well as on addition of water.

PVA and PCL are two of the most biodegradable polymers used and their degradation rates depend on the environmental conditions rather than on the adhesives. In general, it takes several months for these polymers to degrade. Grapevine pruning wounds, on the other hand, are susceptible to infection by fungi for as long as six to seven weeks. Hence, the patches developed in the present work would remain intact until the plant wounds heal.

### Example 7

### Use of Sticky Patches Against Esca

Practical application of the developed sticky nano-textured patches against esca attack and their sustainability under environmental conditions were assessed. The shear stress, sw, on the patch surface was calculated using the Schultz-Grunow formula for the friction law in a turbulent boundary layer on a wall

$${c}_{f} = \frac{{τ}_{w}}{\frac{ρ {U}^{2}}{2}} = \frac{0.370}{{( {log}_{10} {Re}_{x} )}^{2.584}} \qquad ( Eqn 3 )$$

where c_{f} is the dimensionless friction coefficient, ρ is the air density, U is the wind velocity, and the Reynolds number Re=Ux/ν, with x being the cross-section location, and ν being the kinematic viscosity of air. For the estimate, take ρ=1.177 kg/m³, ν=0.15×10⁻⁴ m²/s, and x=0.05 m. The speed of air, U, is assumed to be 22.9 m/s, the maximum speed at a Californian vineyard in April. This wind speed is assigned as level 9 (strong gale) on the 12-point Beaufort scale, which is sufficient enough to break off weak branches and twigs. Then, Eqn (3) yields τ_{w}=1.9 Pa. This stress is to be compared with the adhesive strength Ssh=mg/(W×l)=2Gsh/l. Using the values of Gsh listed in Tables 6, 9 and 10 and 1=5 cm as in the experiments, it is found that τ_{w} is several orders of magnitude smaller than Ssh. Therefore, the patches would not be blown off even by such a strong wind, even after the seventh cycle of loading.

### Example 8

### Silk Sericin Nanofiber Mats

A solution containing soy protein/PVA/silk sericin was electrospun on rayon substrate. EDX spectra of these nanofibers were obtained to detect the presence of soy protein in the as-spun monolithic fibers. The percentage content of different elements of the EDX spectra of monolithic soy protein/PVA/silk sericin nanofibers is shown in Table 11.

TABLE 11

| | Weight | Atomic |
|---|---|---|
| Element | % | % |
| Carbon | 85.83 | 89.83 |
| Oxygen | 15.61 | 12.27 |
| Sodium | 0.60 | 0.33 |
| Phosphorus | 0.69 | 0.28 |
| Sulfur | 0.48 | 0.19 |

The contents of sodium, phosphorus and sulfur reveals the presence of soy in the electrospun nanofibers.

What is claimed is:

1. A biodegradable plant wound dressing comprising a plurality of electrospun nanofibers produced from a blend of at least two different polymers, wherein at least one of the polymers is a biopolymer and said dressing is microorganism impermeable.

2. The biodegradable plant wound dressing of claim 1, wherein the biopolymer comprises a starch, cellulose, hemicellulose, lignin, pullulan, alginate, chitin, chitosan, dextran, or protein.

3. The biodegradable plant wound dressing of claim 1, wherein the biopolymer is derived from biowaste or a by-product.

4. The biodegradable plant wound dressing of claim 1, wherein the other polymer comprises a synthetic polymer.

5. The biodegradable plant wound dressing of claim 4, wherein the synthetic polymer comprises a polyvinyl alcohol, polycaprolactone, polyesteramide, modified polyethylene terephthalate, polylactic acid, polyglycolic acid, polyalkylene carbonate, polyhydroxyalkanoate, poly-3-hydroxybutyrate, poly-3-hydroxyvalerate, poly-3-hydroxybutyrate-co-4-hydroybutyrate, poly-3-hydroxybutyrate-co-3-hydroxyvalerate copolymer, poly-3-hydroxybutyrate-co-3-hydroxyhexanoate, poly-3-hydroxybutyrate-co-3-hydroxyoctanoate, poly-3-hydroxybutyrate-co-3-hydroxy decanoate, poly-3-hydroxybutyrate-co-3-hydroxyoctadecanoate, polybutylene succinate, polybutylene succinate adipate, an aliphatic-aromatic copolyester, polyethylene succinate or a combination thereof.

6. The biodegradable plant wound dressing of claim 1, further comprising at least one adhesive.

7. The biodegradable plant wound dressing of claim 6, wherein the at least one adhesive is water soluble.

8. The biodegradable plant wound dressing of claim 6, wherein the adhesive is electrospun with the blend of at least two different polymers.

9. The biodegradable plant wound dressing of claim 6, wherein the adhesive is electrosprayed onto the electrospun nanofibers.

10. The biodegradable plant wound dressing of claim 6, wherein the wound dressing is characterized as having
(a) a peel force of between 0.0005 N and 0.1500 N;
(b) a normal specific adhesive energy of between 0.01 N/m and 50 N/m;
(c) a shear adhesive specific energy of between 1 N/m and 500 N/m; or
(d) a combination of any one of (a), (b) and (c).

11. The biodegradable plant wound dressing of claim 1, further comprising a base membrane.

12. The biodegradable plant wound dressing of claim 11, wherein the base membrane is biodegradable.

13. The biodegradable plant wound dressing of claim 12, wherein the base membrane comprises rayon.

14. The biodegradable plant wound dressing of claim 1, wherein the dressing comprises pores of less than about 6 microns.

15. A method for producing the biodegradable plant wound dressing of claim 1, comprising blending at least two different polymers, wherein at least one of the polymers is a biopolymer, and electrospinning the blend to produce a biodegradable plant wound dressing.

16. The method of claim 15, further comprising electrospinning an adhesive in combination with the blend of at least two different polymers.

17. The method of claim 15, wherein the at least two different polymers are electrosprayed onto a base membrane prior to electrospinning.

18. The method of claim 15, further comprising electrospraying an adhesive onto the electrospun polymers.

19. A method for preventing microbial infection of a plant wound comprising applying the biodegradable plant wound dressing of claim 1 to a plant wound thereby preventing microbial infection of a plant wound.

20. The method of claim 19, wherein the microbial infection causes vine decline, fungal canker, bacterial canker, blight, or rot.

21. The method of claim 19, wherein the biodegradable plant wound dressing, after being applied to the plant wound, stays intact for at least six weeks.
